(19) United States
(12) Patent Application Publication
(10) Pub. No.: US 2016/0139783 A1
(43) Pub. Date: May 19, 2016

(54) DETECTING SIDEBAR IN DOCUMENT

(71) Applicant: Microsoft Technology Licensing, LLC, Redmond, WA (US)

(72) Inventor: Marko Rakita, Novisad (RS)

(21) Appl. No.: 14/541,091

(22) Filed: Nov. 13, 2014

(51) Int. Cl. G06F 3/0484; G06F 3/0482

(52) U.S. Cl. CPC G06F 3/04847; G06F 3/0482

(57) ABSTRACT

Detection of a sidebar in a document is provided. An application such as a document processing application processes a page of the document to detect the sidebar. Components of the page are analyzed to detect borders. The one or more borders are processed to discard a subset of the one or more borders identified as false positive candidates. In response to detecting the borders, the borders are processed to detect the sidebar that includes the borders. In response to a failure to detect the borders, the components are processed to detect the sidebar that lacks the borders.

### BACKGROUND

People interact with computer applications through user interfaces. While audio, tactile, and similar forms of user interfaces are available, visual user interfaces through a display device are the most common form of a user interface. With the development of faster and smaller electronics for computing devices, smaller size devices such as handheld computers, smart phones, tablet devices, and comparable devices have become common. Such devices execute a wide variety of applications ranging from communication applications to complicated analysis tools. Many such applications render documents through a display and enable users to provide input associated with the applications' operations.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to detecting a sidebar in a document. In some example embodiments, a document processing application may process a page of the document to detect a sidebar, in response to an action selecting the page. Components of the page may be analyzed to detect borders. The one or more borders may be processed to discard a subset of the one or more borders identified as false positive candidates. In response to detecting the borders, the borders may be processed to detect the sidebar that includes the borders. In response to a failure to detect the borders, the components may be processed to detect the sidebar that lacks the borders.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating an example of detecting a sidebar in a document, according to embodiments;

FIG. 2 illustrates an example of detecting a sidebar in a document with borders, according to embodiments;

FIG. 3 illustrates an example of detecting a sidebar in a document with partial borders, according to embodiments;

FIG. 4 illustrates an example of discarding components of a document as a candidate sidebar, according to embodiments;

FIG. 5 illustrates an example of detecting a sidebar in a document without borders, according to embodiments;

FIG. 6 illustrates an example of generating a reading order tree from components of a document to detect a sidebar without borders in the document, according to embodiments;

FIG. 7 is a simplified networked environment, where a system according to embodiments may be implemented;

FIG. 8 illustrates a general purpose computing device, which may be configured to detect a sidebar in a document; and

FIG. 9 illustrates a logic flow diagram for a process to detect a sidebar in a document, according to embodiments.

### DETAILED DESCRIPTION

As briefly described above, a sidebar in a document may be detected by a document processing application, in response to an action selecting the page. Components of a page of the document may be analyzed to detect borders. The one or more borders may be processed to discard a subset of the one or more borders identified as false positive candidates. In response to detecting the borders, the borders may be processed to detect the sidebar that includes the borders. In response to a failure to detect the borders, the components may be processed in a reading order tree to detect the sidebar that lacks the borders.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable memory device includes a hardware device that includes a hard disk drive, a solid state drive, a compact disk, and a memory chip, among others. The computer-readable storage medium can for example be implemented via one or more of a volatile computer memory, a non-volatile memory, a hard drive, and a flash drive.

Throughout this specification, the term “platform” may be a combination of software and hardware components to detect a sidebar in a document. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example embodiments may be found in the following description.

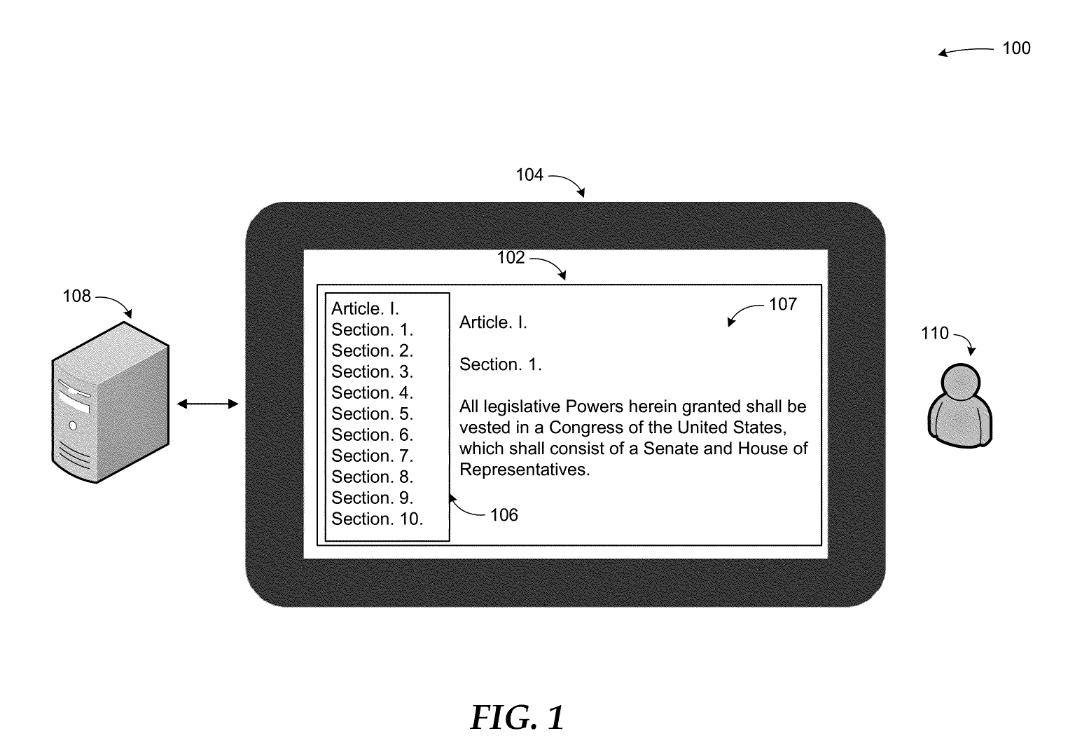

FIG. 1 is a conceptual diagram illustrating an example of a sidebar in a document, according to embodiments.

In a diagram 100, a computing device 104 may execute a document processing application 102. The computing device 104 may include a tablet device, a laptop computer, a desktop computer, and a smart phone, among others. The computing device 104 may display the document processing application 102 to a user 110. The user 110 may be allowed to interact with the document processing application 102 through an input device or touch enabled display component of the computing device 104. The computing device 104 may include a display device such as the touch enabled display component, and a monitor, among others to provide a user interface of the document processing application 102 to the user 110. The document processing application 102 may process a page 107 of a document to detect a sidebar 106 based on an action selecting the page 107. The action may be an interaction of the user 110 with the document processing application 102 to select the page 107. The user 110 may interact with the document processing application 102 with a keyboard based input, a mouse based input, a voice based input, a pen based input, and a gesture based input, among others. The gesture based input may include one or more touch based actions such as a touch action, a swipe action, and a combination of each, among others.

The document presentation application 102 may present the page 107 of a document. The document may be retrieved from a local storage such a storage media, a memory, a hard disk drive, and a solid state drive, among others. The document may also be retrieved from a remote storage such as a server 108 that hosts documents and provides services associated with documents. The page 107 of the document may include a sidebar 106. The sidebar 106 may include text or other content that may include aggregated view of the content provided in the document. The sidebar may also include content related to the content provided in the document.

While the example system in FIG. 1 has been described with specific components including the computing device 104, the document processing application 102, the sidebar 106, embodiments are not limited to these components or system configurations and can be implemented with other system configuration employing fewer or additional components.

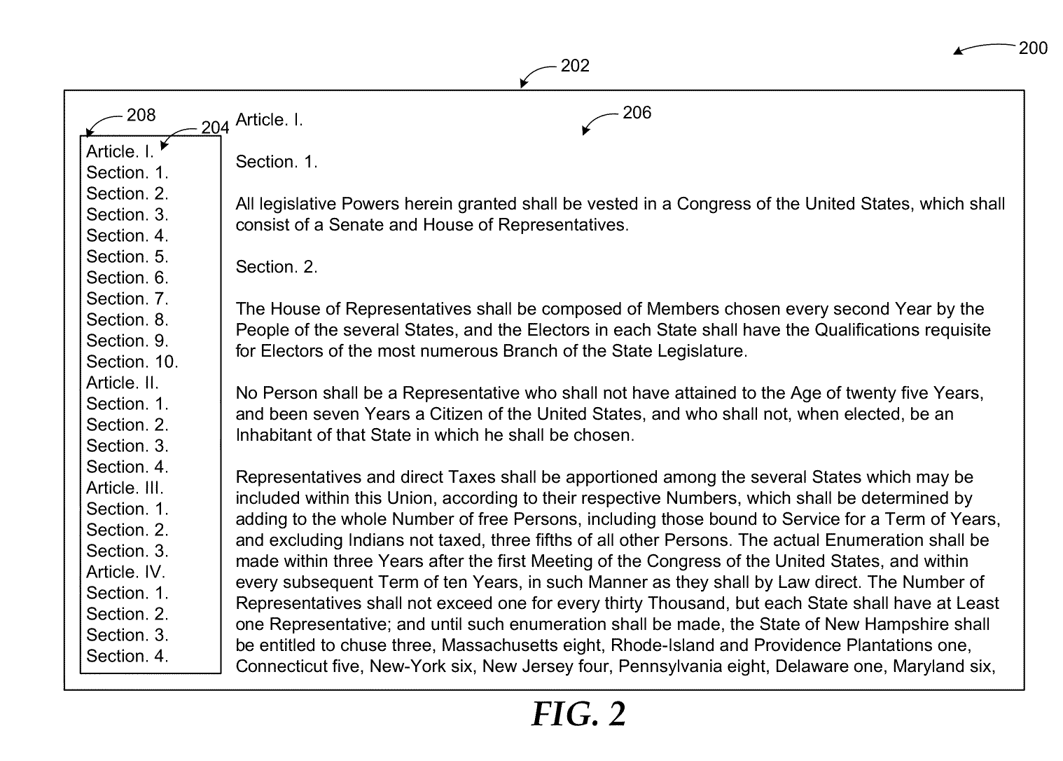

FIG. 2 illustrates an example of detecting a sidebar in a document with borders, according to embodiments.

In a diagram 200, a page 202 of a document may be processed by a document processing application. The page may include a body component 206 that includes content such as text, graphics, images, video, and audio, among others. The page may be processed to detect a component that may be identified as a sidebar 204.

The sidebar 204 may include aggregated content that may summarize the content in the body component 206. The sidebar 204 may also include content related to the content of the body component 206. The sidebar 204 may also include content that is un-related to the content of the body component 206. The sidebar 204 may be contained by borders 208. The borders 208 may include a rectangle that encompasses the content of the sidebar 204. The borders 208 may encompass a bounding box with a top coordinate, a bottom coordinate, a left coordinate, and a right coordinate associated with edges of the bounding box. Alternatively, the border 208 may also include side lines, crooked lines, and askew lines, among others.

The sidebar 204 may also be distinguished from the body component 206 based on formatting attributes associated with the sidebar 204. The background color or texture of the sidebar 204 may be different from the background color or texture of the body component 206. The font attributes of the sidebar 204 may also be different from the font attributes of the body component 206. In an example scenario, a different font type, font color, or font size may be used by the sidebar 204 compared to the font type, font color, or font size of the body component 206.

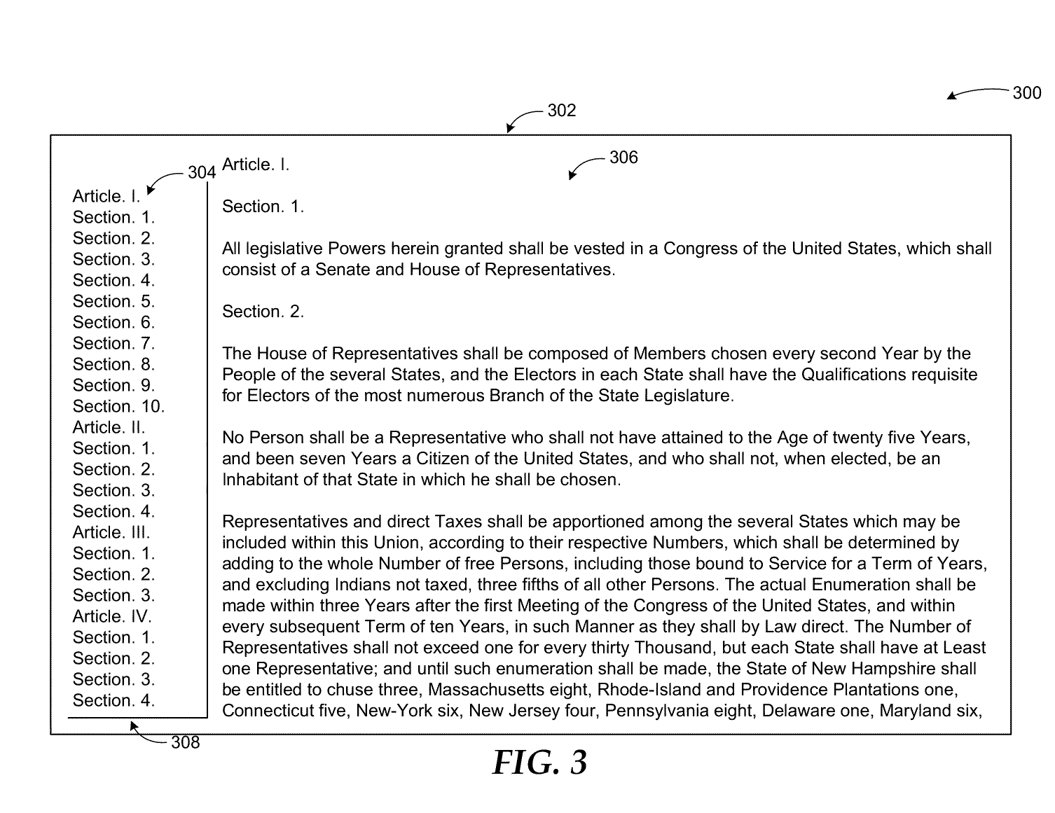

FIG. 3 illustrates an example of detecting a sidebar in a document with partial borders, according to embodiments.

In a diagram 300, a document processing application may display a page 302 of a document. The page 302 may include a body component 306 that includes content such as text, and graphics, among others. The body component 306 may be located adjacent to a sidebar 304.

The sidebar 304 may be identified through partial borders 308. The partial borders 308 may include lines that separate the side bar 304 from the body component 306. The partial borders 308 may not encompass the sidebar 304 to present a visually distinct view of the sidebar 304 from the body component 306. Attributes of the content displayed on the sidebar 304 may be detected to vary from the content displayed on the body component 306. A font type, a font color, or a font size of the sidebar 304 may vary from the font type, a font color, or a font size of the body component 306 to distinguish the sidebar 304 from the body component 306.

The partial borders 308 may be detected from components of the page 302 that may not be visible. An example may include a transparent component such as a transparent line or a line that has a same color as a background color of the sidebar 304. The partial borders 308 may also be identified from components of the page 302 that are defined by a bounding area with a different color than a background color of the page 302.

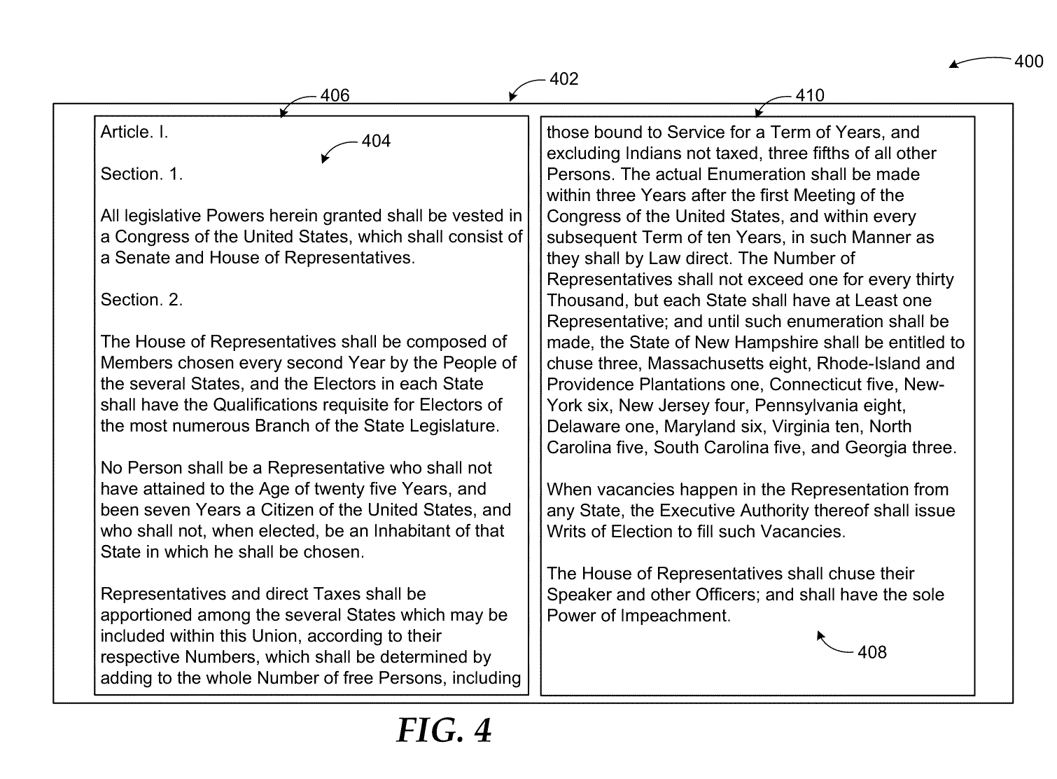

FIG. 4 illustrates an example of discarding components of a document as a candidate sidebar, according to embodiments.

In a diagram 400, a document processing application may process candidate sidebars to detect a sidebar in a page 402. The document processing application may detect a first component of the page 402 as a first candidate sidebar 404 bound by borders 406. A second component of the page 402 may be detected as a second candidate sidebar 408 bound by borders 410. The borders 406 and 410 may be analyzed to detect a common height and a horizontal alignment. In response to detecting the common height and the horizontal alignment, the borders 406 and 410 may be discarded to remove the borders 406 and 410 as candidates in consideration as the sidebar of the page 402. Alternatively, in response to detecting a common width and vertical alignment, the borders 406 and 410 may be unified into one border encompassing a merged bounding box.

In an example scenario, a subset of borders in a page of the document may be discarded to remove a bounded component from consideration as a sidebar in response to detecting the subset to include attributes that fail criteria of a sidebar. A subset of the borders may be discarded in response to detecting a height of the border that is larger than a height ratio of the page 402. The height ratio may include 3/5 or 4/5. The height ratio may also be user configurable and dynamically configurable based on a document type of the document.

A subset of the borders may also be discarded in response to detecting a horizontal location of the subset that is located in a horizontal width ratio of the page from a left edge of the page. The subset may also be discarded in response to detecting the horizontal location of the subset that is located in the horizontal width ratio from a right edge of the page. The horizontal width ratio may include 3/8 or 5/11. The horizontal width ratio may also be user configurable as well as dynamically configurable based on a document type of the document.

A subset of the borders may also be discarded in response to detecting the subset to intersect a text of the page 402. A subset of the borders may also be discarded in response to detecting the subset to encompass an image frame of the page 402. A subset of the borders may also be discarded in response to detecting the subset encompassing a bounding box that includes text content covering a surface area of the bounding box below an area ratio. The area ratio may include 30%. The area ratio may be user configurable or dynamically configurable based on a document type of the document. A subset of the borders may also be discarded in response to detecting that the subset intersect and share an area ratio of a common bounding box area. The area ratio may include 93%. The area ratio may be user configurable or dynamically configurable based on a document type of the document. One of the borders in the subset may be identified as lining a bounded component that may be identified as the sidebar. The border may be selected to identify the sidebar.

In another example scenario, the sidebar is detected from two candidate sidebars that are located within a horizontal width ratio from a left edge of the page 402 or a horizontal width ratio from a right edge of the page 402. The horizontal width ratio may include 1/5. The horizontal width ratio may be user configurable or dynamically configurable based on a document type of the document. Other sidebars may also be discarded. The other sidebars may fail to align with horizontal width ratio attributes

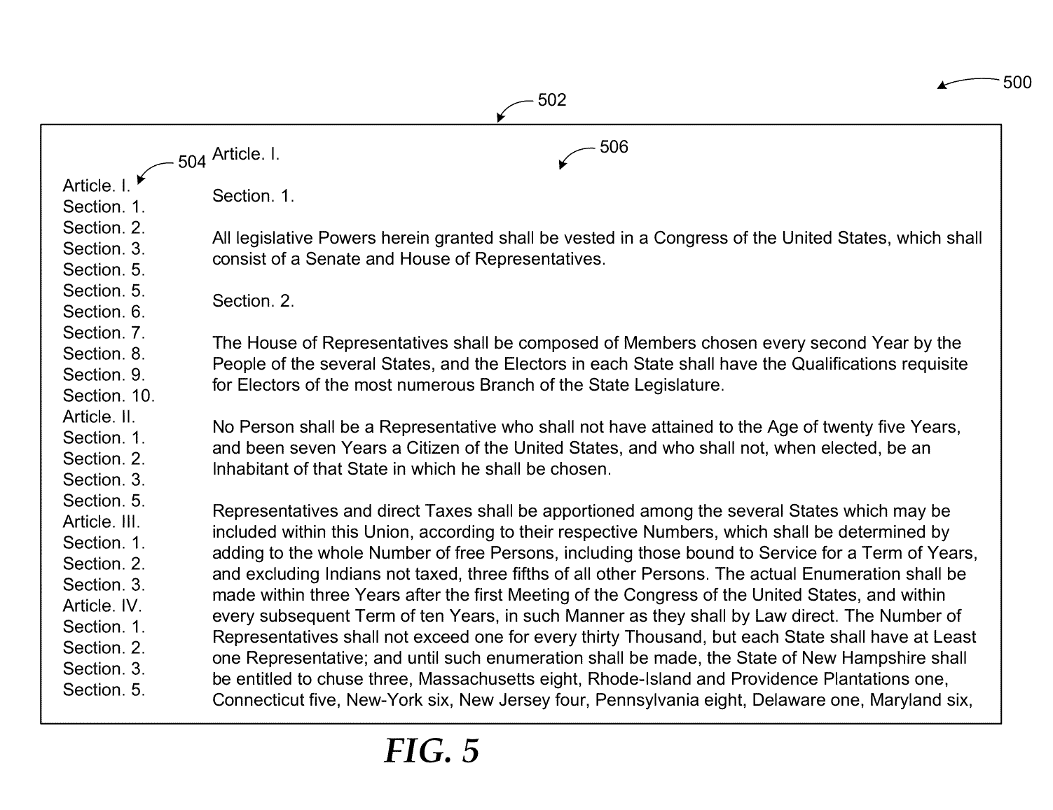

FIG. 5 illustrates an example of detecting a sidebar in a document without borders, according to embodiments.

In a diagram 500, a page 502 may be processed by a document processing application to detect a sidebar 504 that lacks borders. The sidebar 504 may be located adjacent to a body component 506 that includes content such as text, and graphics, among others. A reading order tree may be generated from the components of the page 502. A root element of the reading order tree may include the sidebar 504 that lacks the borders.

An element in the reading order tree may be processed to remove a corresponding component, in consideration as the sidebar, in response to detecting an attribute of the element fail to meet a criteria associated with the sidebar. An element of the reading order tree may be discarded in response to detecting the element to include a branch of other elements. An element of the reading order tree may also be discarded in response to detecting the element to have an element width within a ratio of a column width of a column of the page 502. In some examples, the ratio may include 1.2 or 1.4. The ratio may be user configurable and dynamically configurable based on a document type of the document. The element of the reading order tree may be discarded to differentiate the element such as a text column from a sidebar. A sidebar may also be differentiated from a text column by comparing textual characteristics such as font size, font color, font type. A candidate sidebar that shares textual characteristics with a text column may be discarded.

An element of the reading order tree may be discarded as a candidate sidebar in response to detecting the element to include a graphic element and no other element. The graphic element may include an image, a graphic, a video, and an audio, among others. In response to detecting a text of the page 502 intersecting a border of a bounding box that encompasses an element of the reading order tree, the element may be discarded as a candidate sidebar.

An element of the reading order tree may be detected to have an overlap with another element of the reading order tree. A width of the element may be detected to be smaller than or equal to a width of the other element. The element may be identified as the sidebar that lacks borders. Upon detecting the width of the element to be larger than a width of the other element, the element may be discarded as a candidate sidebar.

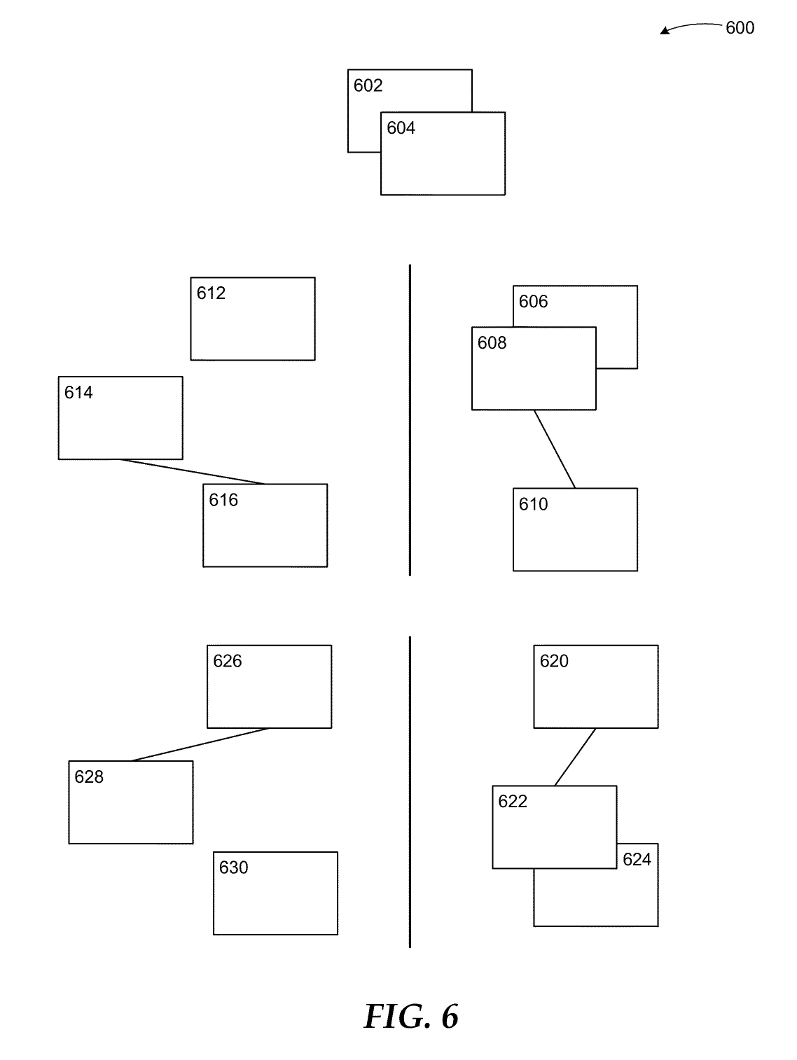

FIG. 6 illustrates an example of generating a reading order tree from components of a document to detect a sidebar without borders in the document, according to embodiments.

A reading order tree may be generated to compute a value for the reading order complexity. Components of a page of the document may be inserted into a reading order tree as elements to generate the reading order tree. The reading order tree may be organized based on an analysis of the elements as shown in diagram 600. Two elements may be detected to be connected if they overlap such as element 602 that overlaps with an element 604. Following element pairs are connected in a computation according to embodiments: elements 602 and 604, elements 614 and 616, elements 608 and 610, elements 608 and 606, elements 628 and 626, elements 620 and 622, elements 622 and 624.

Thus, to generate the reading order, elements are connected. One example case may be when elements are intersecting, like elements 602 and 604. Another example case may be when elements have horizontal overlap, like elements 612 and 616, and elements 606 and 610. However, an exception from this case is when elements that have horizontal overlap, also have another element between them that is already connected to at least one of those two elements. Elements, which are not connected include elements 612 and 614, elements 612 and 616, elements 606 and 610, elements 628 and 630, elements 626 and 630, elements 620 and 624.

The elements may be processed to detect a root element as a sidebar through one or more criteria that match the sidebar. A sidebar may also be identified as a separative feature of the pages. Alternatively, in response to detecting the pages that lack an outlined sidebar, a layout analysis may be performed on the pages to detect the sidebar. The layout analysis may also be performed on the pages to adjust a confidence score associated with detecting the sidebar. A value may be assigned to the sidebar in response to locating the sidebar on a subset of the pages. The value may depend on a confidence score associated with identifying the sidebar. The confidence score may be assigned based on attributes of the sidebar such as borders that increase the confidence score or a lack of borders that decrease the confidence score. In some examples, a document may not have notion of many of the “separative” features depending on its format. For example, some document formats may not have notion of a sidebar. For such document formats, layout analysis algorithms may be applied to detect the presence of the sidebar. This approach may also be used to adjust confidence of such a feature.

The technical advantage of detecting a sidebar in a document may include improved usability of user interfaces that present pages of documents while distinguishing sidebars from other content on a page of a document compared to legacy document presentation solutions.

The example scenarios and schemas in FIG. 1 through 6 are shown with specific components, data types, and configurations. Embodiments are not limited to systems according to these example configurations. Detecting a sidebar in a document may be implemented in configurations employing fewer or additional components in applications and user interfaces. Furthermore, the example schema and components shown in FIG. 1 through 6 and their subcomponents may be implemented in a similar manner with other values using the principles described herein.

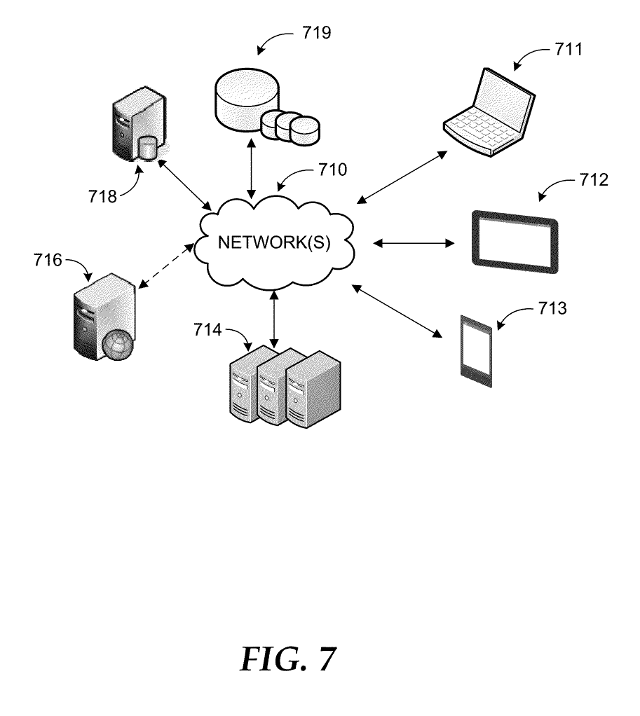

FIG. 7 is an example networked environment, where embodiments may be implemented. A document processing application configured to detect a sidebar in a document may be implemented via software executed over one or more servers 714 such as a hosted service. The platform may communicate with client applications on individual computing devices such as a smart phone 713, a mobile computer 712, or desktop computer 711 (‘client devices’) through network(s) 710.

Client applications executed on any of the client devices 711-713 may facilitate communications via application(s) executed by servers 714, or on individual server 716. A document processing application may analyze components of a page of a document to detect borders. In response to detecting the borders, the borders may be processed to detect the sidebar that includes the borders. In response to a failure to detect the borders, the components may be processed in a reading order tree to detect the sidebar that lacks the borders. The document processing application may store data associated with the document in data store(s) 719 directly or through database server 718.

Network(s) 710 may comprise any topology of servers, clients, Internet service providers, and communication media. A system according to embodiments may have a static or dynamic topology. Network(s) 710 may include secure networks such as an enterprise network, an unsecure network such as a wireless open network, or the Internet. Network(s) 710 may also coordinate communication over other networks such as Public Switched Telephone Network (PSTN) or cellular networks. Furthermore, network(s) 710 may include short range wireless networks such as Bluetooth or similar ones. Network(s) 710 provide communication between the nodes described herein. By way of example, and not limitation, network(s) 710 may include wireless media such as acoustic, RF, infrared and other wireless media.

Many other configurations of computing devices, applications, data sources, and data distribution systems may be employed to detect a sidebar in a document. Furthermore, the networked environments discussed in FIG. 7 are for illustration purposes only. Embodiments are not limited to the example applications, modules, or processes.

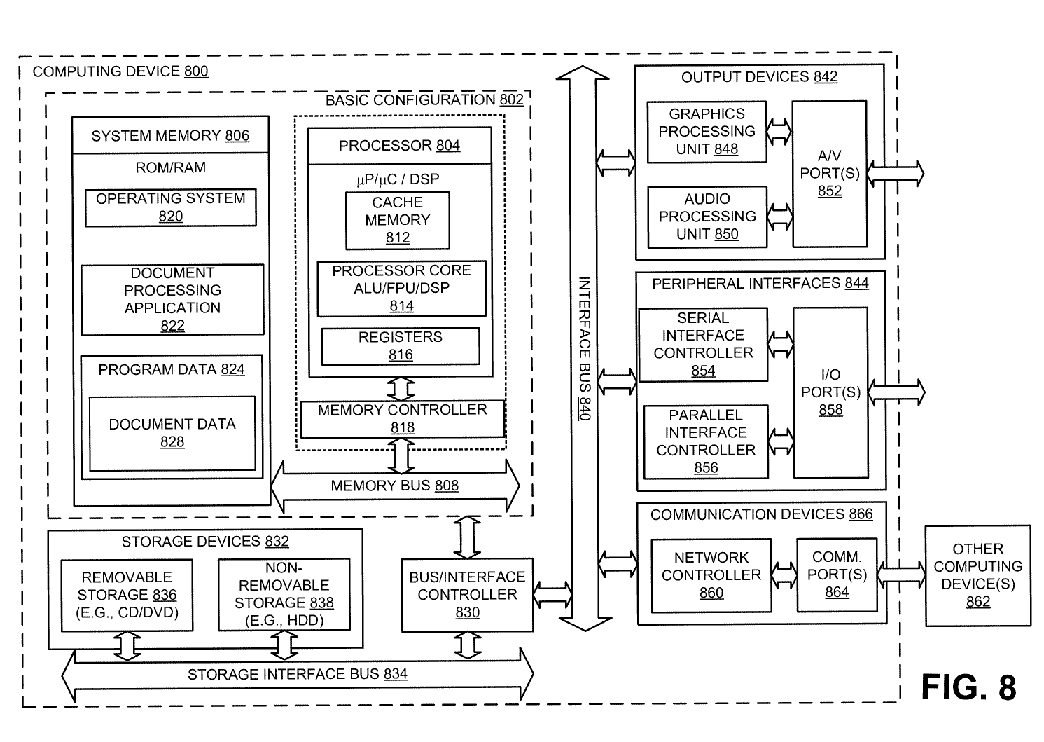

FIG. 8 illustrates a general purpose computing device, which may be configured to detect a sidebar in a document, arranged in accordance with at least some embodiments described herein.

For example, the computing device 800 may be used to detect a sidebar in a document. In an example of a basic configuration 802, the computing device 800 may include one or more processors 804 and a system memory 806. A memory bus 808 may be used for communication between the processor 804 and the system memory 806. The basic configuration 802 may be illustrated in FIG. 8 by those components within the inner dashed line.

Depending on the desired configuration, the processor 804 may be of any type, including, but not limited to, a microprocessor (μP), a microcontroller (μC), a digital signal processor (DSP), or any combination thereof. The processor 804 may include one more levels of caching, such as a level cache memory 812, a processor core 814, and registers 816. The processor core 814 may include an arithmetic logic unit (ALU), a floating point unit (FPU), a digital signal processing core (DSP Core), or any combination thereof. A memory controller 818 may also be used with the processor 804, or in some implementations, the memory controller 818 may be an internal part of the processor 804.

Depending on the desired configuration, the system memory 806 may be of any type including but not limited to volatile memory (such as RAM), non-volatile memory (such as ROM, flash memory, etc.), or any combination thereof. The system memory 806 may include an operating system 820, a document processing application 822, and a program data 824. The document processing application 822 may analyze components of a page of a document to detect borders. In response to detecting the borders, the borders may be processed to detect the sidebar that includes the borders. In response to a failure to detect the borders, the components may be processed in a reading order tree to detect the sidebar that lacks the borders. Components of the document processing application 822 (such as a user interface) may also be displayed on a display device associated with the computing device 800. An example of the display device may include a hardware screen that may be communicatively coupled to the computing device 800. The display device may include a touch based device that detects gestures such as a touch action. The display device may also provide feedback in response to detected gestures (or any other form of input) by transforming a user interface of the document processing application 822, displayed by the touch based device. The program data 824 may also include, among other data, a document data 828, or the like, as described herein. The document data 828 may include a sidebar, and a body component, among others.

The computing device 800 may have additional features or functionality, and additional interfaces to facilitate communications between the basic configuration 802 and any desired devices and interfaces. For example, a bus/interface controller 830 may be used to facilitate communications between the basic configuration 802 and one or more data storage devices 832 via a storage interface bus 834. The data storage devices 832 may be one or more removable storage devices 836, one or more non-removable storage devices 838, or a combination thereof. Examples of the removable storage and the non-removable storage devices may include magnetic disk devices, such as flexible disk drives and hard-disk drives (HDD), optical disk drives such as compact disk (CD) drives or digital versatile disk (DVD) drives, solid state drives (SSD), and tape drives, to name a few. Example computer storage media may include volatile and nonvolatile, removable, and non-removable media implemented in any method or technology for storage of information, such as computer-readable instructions, data structures, program modules, or other data.

The system memory 806, the removable storage devices 836, and the non-removable storage devices 838 may be examples of computer storage media. Computer storage media may include, but may not be limited to, RAM, ROM, EEPROM, flash memory or other memory technology, CD-ROM, digital versatile disks (DVD), solid state drives, or other optical storage, magnetic cassettes, magnetic tape, magnetic disk storage or other magnetic storage devices, or any other medium which may be used to store the desired information and which may be accessed by the computing device 800. Any such computer storage media may be part of the computing device 800.

The computing device 800 may also include an interface bus 840 for facilitating communication from various interface devices (for example, one or more output devices 842, one or more peripheral interfaces 844, and one or more communication devices 866) to the basic configuration 802 via the bus/interface controller 830. Some of the example output devices 842 may include a graphics processing unit 848 and an audio processing unit 850, which may be configured to communicate to various external devices, such as a display or speakers via one or more A/V ports 852. One or more example peripheral interfaces 844 may include a serial interface controller 854 or a parallel interface controller 856, which may be configured to communicate with external devices, such as input devices (for example, keyboard, mouse, pen, voice input device, touch input device, etc.) or other peripheral devices (for example, printer, scanner, etc.) via one or more I/O ports 858. An example communication device 866 may include a network controller 860, which may be arranged to facilitate communications with one or more other computing devices 862 over a network communication link via one or more communication ports 864. The one or more other computing devices 862 may include servers, client equipment, and comparable devices.

The network communication link may be one example of a communication media. Communication media may be embodied by computer-readable instructions, data structures, program modules, or other data in a modulated data signal, such as a carrier wave or other transport mechanism, and may include any information delivery media. A “modulated data signal” may be a signal that has one or more of the modulated data signal characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term computer-readable media, as used herein, may include both storage media and communication media.

The computing device 800 may be implemented as a part of a general purpose or specialized server, mainframe, or similar computer, which includes any of the above functions. The computing device 800 may also be implemented as a personal computer including both laptop computer and non-laptop computer configurations.

Example embodiments may also include methods to detect a sidebar in a document. These methods may be implemented in any number of ways, including the structures described herein. One such way may be by machine operations, using devices of the type described in the present disclosure. Another optional way may be for one or more of the individual operations of the methods to be performed in conjunction with one or more human operators performing some of the operations while other operations may be performed by machines. These human operators need not be co-located with each other, but each may be with a machine that performs a portion of the program. In other examples, the human interaction may be automated such as by pre-selected criteria that may be machine automated.

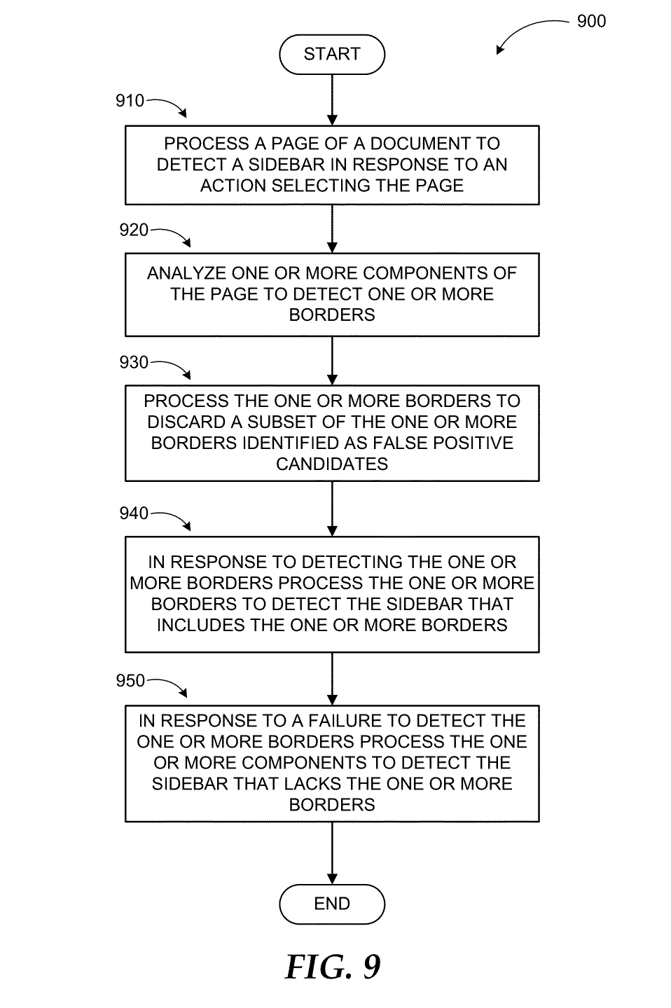

FIG. 9 illustrates a logic flow diagram for a process to detect a sidebar in a document, according to embodiments. Process 900 may be implemented on a document processing application.

Process 900 begins with operation 910, where a page of a document may be processed to detect a sidebar, in response to an action selecting the page. At operation 920, components of the page may be analyzed to detect borders. At operation 930, processing the one or more borders to discard a subset of the one or more borders identified as false positive candidates. In response to detecting the borders, the borders may be processed to detect a sidebar that includes the borders, at operation 940. At operation 950, in response to a failure to detect the borders, the components may be processed to detect the sidebar that lacks the borders.

The operations included in process 900 are for illustration purposes. A document processing application according to embodiments may be implemented by similar processes with fewer or additional steps, as well as in different order of operations using the principles described herein.

According to some examples, a method that is executed on a computing device to detect a sidebar in a document may be described. The method may further include processing a page of the document to detect the sidebar, in response to an action selecting the page, analyzing one or more components of the page to detect one or more borders, processing the one or more borders to discard a subset of the one or more borders identified as false positive candidates, in response to detecting the one or more borders, processing the one or more borders to detect the sidebar that includes the one or more borders, and in response to a failure to detect the one or more borders, processing the one or more components to detect the sidebar that lacks the one or more borders.

According to other examples, the method may further include detecting the one or more borders from the one or more components that include one or more from a set of: a rectangle, a sideline, a crooked line, and an askew line. The one or more borders may be detected from the one or more components that are not visible and the one or more borders may be identified from the one or more components that are defined by a bounding area with a different color than a background color of the page. The borders may be detected to encompass a bounding box and the bounding box may be identified with a top coordinate, a bottom coordinate, a left coordinate, and a right coordinate associated with edges of the bounding box.

According to further examples, the method may further include discarding the subset of the one or more borders in response to detecting the subset to have: a height that is larger than a height ratio of the page, a horizontal location located on a horizontal width ratio of the page from a left edge of the page, and the horizontal location located on the horizontal width ratio of the page from a right edge of the page, and utilizing one from a set of: 3/5 and 4/5 as the height ratio and one from a set of: 3/8 and 5/11 as the horizontal ratio. The subset of the one or more borders may be discarded in response to detecting the subset to bound an image frame. The subset of the one or more borders may be discarded in response to detecting the subset to intersect a text of the page. The subset of the one or more borders may be discarded in response to detecting the subset to intersect and share a ratio of a common bounding box area. The subset of the one or more borders may be discarded in response to detecting the subset to have a common height and a horizontal alignment. The sidebar that includes the one or more borders may be detected from one or more sidebar candidates that are located within one from a set of: a horizontal width ratio from a left edge of the page and the horizontal width ratio from a right edge of the page.

According to some examples, a computing device to detect a sidebar in a document may be described. The computing device may include a display device, a memory, a processor coupled to the memory and the display device. The processor may be configured to execute a document processing application in conjunction with instructions stored in the memory. The document processing application may be configured to process a page of the document to detect the sidebar, in response to an action selecting the page, analyze one or more components of the page to detect one or more borders, where the one or more borders include one or more from a set of: a rectangle, a sideline, a crooked line, and an askew line, process the one or more borders to discard a subset of the one or more borders identified as false positive candidates in response to detecting the one or more borders, process the one or more borders to detect the sidebar that includes the one or more borders, in response to a failure to detect the one or more borders, process the one or more components to detect the sidebar that lacks the one or more borders, and present the sidebar on the display device.

According to other examples, the document processing application is further configured to generate a reading order tree from the one or more components, where a root element in the reading order tree includes the sidebar that lacks the one or more borders. An element of the reading order tree may be discarded in response to detecting the element to include a branch. An element of the reading order tree may be discarded in response to detecting the element to have an element width within a ratio of a column width of a column of the page. An element of the reading order tree may be detected to have an overlap with another element of the reading order tree, where a width of the element is smaller than a width of the other element and the element may be identified as the sidebar that lacks the one or more borders. An element of the reading order tree that includes a graphic element and no other element may be discarded.

According to some examples, a computer-readable memory device with instructions stored thereon to detect a sidebar in a document may be described. The instructions may include actions that are similar to the method described above.

According to some examples, a means to detect a sidebar in a document may be described. The means to detect a sidebar may include a means for processing a page of the document to detect the sidebar, in response to an action selecting the page, a means for analyzing one or more components of the page to detect one or more borders, a means for processing the one or more borders to discard a subset of the one or more borders identified as false positive candidates, a means for processing the one or more borders to detect the sidebar that includes the one or more borders, in response to detecting the one or more borders, and a means for processing the one or more components to detect the sidebar that lacks the one or more borders, in response to a failure to detect the one or more borders.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device to detect a sidebar in a document, the method comprising:
processing a page of the document to detect the sidebar, in response to an action selecting the page;
analyzing one or more components of the page to detect one or more borders;
processing the one or more borders to discard a subset of the one or more borders identified as false positive candidates;
in response to detecting the one or more borders, processing the one or more borders to detect the sidebar that includes the one or more borders; and
in response to a failure to detect the one or more borders, processing the one or more components to detect the sidebar that lacks the one or more borders.

2. The method of claim 1, further comprising:
detecting the one or more borders from the one or more components that include one or more from a set of: a rectangle, a sideline, a crooked line, and an askew line.

3. The method of claim 1, further comprising:
detecting the one or more borders from the one or more components that are not visible; and
identifying the one or more borders from the one or more components that are defined by a bounding area with a different color than a background color of the page.

4. The method of claim 1, further comprising:
detecting the borders to encompass a bounding box; and
identifying the bounding box with a top coordinate, a bottom coordinate, a left coordinate, and a right coordinate associated with edges of the bounding box.

5. The method of claim 1, further comprising:
discarding the subset of the one or more borders in response to detecting the subset to have:
a height that is larger than a height ratio of the page,
a horizontal location located on a horizontal width ratio of the page from a left edge of the page, and
the horizontal location located on the horizontal width ratio of the page from a right edge of the page.

6. The method of claim 5, further comprising:
utilizing one from a set of: 3/5 and 4/5 as the height ratio and one from a set of: 3/8 and 5/11 as the horizontal ratio.

7. The method of claim 1, further comprising:
discarding the subset of the one or more borders in response to detecting the subset to bound an image frame.

8. The method of claim 1, further comprising:
discarding the subset of the one or more borders in response to detecting the subset to intersect a text of the page.

9. The method of claim 1, further comprising:
discarding the subset of the one or more borders in response to detecting the subset to intersect and share a ratio of a common bounding box area.

10. The method of claim 1, further comprising:
discarding the subset of the one or more borders in response to detecting the subset to have a common height and a horizontal alignment.

11. The method of claim 1, further comprising:
detecting the sidebar that includes the one or more borders from one or more sidebar candidates that are located within one from a set of: a horizontal width ratio from a left edge of the page and the horizontal width ratio from a right edge of the page.

12. A computing device to detect a sidebar in a document, the computing device comprising:
a display device;
a memory;
a processor coupled to the memory and the display device, the processor executing a document processing application in conjunction with instructions stored in the memory, wherein the document processing application is configured to:
process a page of the document to detect the sidebar, in response to an action selecting the page;
analyze one or more components of the page to detect one or more borders, wherein the one or more borders include one or more from a set of: a rectangle, a sideline, a crooked line, and an askew line;
process the one or more borders to discard a subset of the one or more borders identified as false positive candidates;
in response to detecting the one or more borders, process the one or more borders to detect the sidebar that includes the one or more borders;
in response to a failure to detect the one or more borders, process the one or more components to detect the sidebar that lacks the one or more borders; and
present the sidebar on the display device.

13. The computing device of claim 12, wherein the document processing application is further configured to:
generate a reading order tree from the one or more components, wherein a root element in the reading order tree includes the sidebar that lacks the one or more borders.

14. The computing device of claim 13, wherein the document processing application is further configured to:
discard an element of the reading order tree in response to detecting the element to include a branch.

15. The computing device of claim 13, wherein the document processing application is further configured to:
discard an element of the reading order tree in response to detecting the element to have an element width within a ratio of a column width of a column of the page.

16. The computing device of claim 13, wherein the document processing application is further configured to:
detect an element of the reading order tree to have an overlap with another element of the reading order tree, wherein a width of the element is smaller than a width of the other element; and
identify the element as the sidebar that lacks the one or more borders.

17. The computing device of claim 13, wherein the document processing application is further configured to:
discard an element of the reading order tree that includes a graphic element and no other element.

18. A computer-readable memory device with instructions stored thereon to detect a sidebar from a document, the instructions comprising:
processing a page of the document to detect the sidebar, in response to an action selecting the page;
analyzing one or more components of the page to detect one or more borders, wherein the one or more borders include one or more from a set of: a rectangle, a sideline, a crooked line, and an askew line;
processing the one or more borders to discard a subset of the one or more borders identified as false positive candidates;
in response to detecting the one or more borders, processing the one or more borders to detect the sidebar that includes the one or more borders; and
in response to a failure to detect the one or more borders, processing the one or more components to detect the sidebar that lacks the one or more borders.

19. The computer-readable memory device of claim 18, wherein the instructions further comprise:
discarding the subset of the one or more borders in response to detecting the subset to have:
a height that is larger than a height ratio of the page,
a horizontal location located on a horizontal width ratio of the page from a left edge of the page, and
the horizontal location located on the horizontal width ratio of the page from a right edge of the page; and
utilizing one from a set of: 3/5 and 4/5 as the height ratio and one from a set of: 3/8 and 5/11 as the horizontal ratio.

20. The computer-readable memory device of claim 18, wherein the instructions further comprise:
generating a reading order tree from the one or more components, wherein a root element in the reading order tree includes the sidebar without the one or more borders; and
detecting an element of the reading order tree to have an overlap with another element of the reading order tree, wherein a width of the element is smaller than a width of the other element; and
identifying the element as the sidebar that lacks the one or more borders.
